(19) United States
(12) Patent Application Publication
(10) Pub. No.: US 2017/0076425 A1
(43) Pub. Date: Mar. 16, 2017

(54) ELECTRONIC DEVICE AND METHOD FOR DISPLAYING AN IMAGE ON HEAD MOUNTED DISPLAY DEVICE

(71) Applicant: SAMSUNG DISPLAY CO., LTD., Yongin-si (KR)

(72) Inventor: Nicholas Folse, Asan-si (KR)

(21) Appl. No.: 15/170,815

(22) Filed: Jun. 1, 2016

(30) Foreign Application Priority Data
Sep. 16, 2015 (KR) 10-2015-0130778

(51) Int. Cl. G06T 3/40; G02B 27/01; G06F 3/01

(52) U.S. Cl. CPC G06T 3/40; G06F 3/017; G02B 27/0179; G02B 27/0172; G02B 2027/014; G02B 2027/0134

(57) ABSTRACT

An electronic device includes a processor configured to generate an oversized image by rendering an externally received input image, an image buffer configured to store the oversized image, a mask image buffer configured to store a mask image, which is smaller than the oversized image, a display device configured to apply, in real time, an XY offset to the oversized image based on orientation data to generate an offset image, and blend the offset image with the mask image to display an output image, which is smaller than the oversized image, and a motion tracking module configured to sense a movement of the display device and generate the orientation data.

### CROSS REFERENCE TO RELATED APPLICATION

This application claims priority to, and the benefit of, Korean Patent Applications No. 10-2015-0130778, filed on Sep. 16, 2015 in the Korean Intellectual Property Office (KIPO), the disclosure of which is hereby incorporated by reference herein in its entirety.

### BACKGROUND

1. Field

Example embodiments of the inventive concept relate to electronic devices having a head mounted display (HMD) device, and methods for displaying an image on the HMD device.

2. Discussion of Related Art

A display device, such as a head-mounted display (HMD) device, may be configured to provide augmented reality experiences by displaying virtual images over a real-world background that is viewable through the display. As a user of a see-through display device changes their location and/or orientation in a use environment, the device detects the movements of the user, and updates displayed images accordingly.

However, a number of processing steps that are used to update an image in response to detected motion may cause a high latency. The high latency (and a system delay) is perceived by a user that is using the HMD device, such that motion sickness, nausea and/or the like may occur. Further, latency is generated in overlaying a background image and an object image, such that realism of the see-through display (e.g., synchronization between a virtual world and the real world) is decreased. Although motion prediction methods and frame interleaving methods have been researched for achieving low latency, these algorithms cannot account for unexpected or sudden movements, and cannot reduce an overall system delay.

### SUMMARY

Example embodiments provide an electronic device that is capable of compensating an image at a high speed to reduce latency.

Example embodiments provide a method for displaying an image on a head mounted display device.

According to example embodiments, a display device may include a processor configured to generate an oversized image by rendering an externally received input image, an image buffer configured to store the oversized image, a mask image buffer configured to store a mask image, which is smaller than the oversized image, a display device configured to apply, in real time, an XY offset to the oversized image based on orientation data to generate an offset image, and blend the offset image with the mask image to display an output image, which is smaller than the oversized image, and a motion tracking module configured to sense a movement of the display device and generate the orientation data.

In example embodiments, the display device may include a display driver configured to directly receive the orientation data from the motion tracking module, to directly receive the mask image from the mask image buffer, to generate XY offset data corresponding to the XY offset based on the orientation data, and to generate output image data by blending the offset image with the mask image, and a display panel, including a plurality of pixels, configured to display the output image based on the output image data.

In example embodiments, the display driver may generate the XY offset data while the processor performs the oversize rendering.

In example embodiments, the display driver may shift the oversized image within a size of the image buffer based on the orientation data.

In example embodiments, the display driver may apply the XY offset to the oversized image at set scan periods.

In example embodiments, the display driver may apply the XY offset to the oversized image at set frames.

In example embodiments, the display driver may include an offset compensator configured to calculate a shift displacement of the display device, within a set time period, based on the orientation data to generate the XY offset data, and apply the XY offset to the oversized image to generate the offset image which is shifted in at least one of an X-axis direction or a Y-axis direction on a two-dimensional plane, and an output image data generator configured to blend the offset image with the mask image to generate the output image data corresponding to the output image.

In example embodiments, the offset image may be shifted in a direction corresponding to a direction of the shift displacement.

In example embodiments, the offset image may be shifted in a direction opposite to a direction of the shift displacement.

In example embodiments, the display driver may further include a data driver configured to generate a data signal based on the output image data, and to provide the data signal to the display panel via a data line, and a scan driver configured to provide a scan signal to the display panel via a scan line.

In example embodiments, the display device may be a head mounted display (HMD) device.

In example embodiments, the input image may be a stereoscopic image having a left-eye image and a right-eye image.

In example embodiments, the processor may perform the oversized image rendering for each of the left-eye image and the right-eye image.

In example embodiments, each of the left-eye image and the right-eye image may include an overlay image for an augmented reality see-through display.

In example embodiments, the processor may further perform filtering and smoothing to eliminate noise in the input image caused by the movement.

According to example embodiments, a method for displaying an image on a head mounted display (HMD) device may include sensing, by a motion tracking module, a movement of the HMD device to obtain orientation data, generating, by a processor, an oversized image by rendering a left-eye image and a right-eye image which are externally provided, applying, by a display driver, in real time, an XY offset to the oversized image based on the orientation data, applying the XY offset to the oversized image to generate an offset image, and generating, by the display driver, output image data by blending an offset image with a mask image, which is smaller than the oversized image.

In example embodiments, the method may further include directly transmitting the orientation data from the motion tracking module to the display driver.

In example embodiments, the method may further include generating the XY offset data using the display driver while the processor performs the oversized image rendering.

In example embodiments, the method may further include applying the XY offset to the oversized image at set scan periods.

In example embodiments, the method may further include shifting the offset image corresponding to a shift displacement of the HMD device within a set time period.

Therefore, the electronic device having the HMD device, and the method for displaying image of the HMD device, according to example embodiments, may include a processor for performing the image process (including the oversize rendering) at a high speed, and may include the display driver for performing the XY offset at substantially the same time as the image processing, such that the latency of image display, and such that the entire system delay, may be significantly reduced. Thus, it is possible that the electronic device applies the XY offset to display images in real time to reflect the sudden movement of the display device or of the user's head. Therefore, inconvenience in using the HMD device, such as motion sickness, and nausea, etc., may be decreased, and the realism of the augmented reality experiences may be improved.

### BRIEF DESCRIPTION OF THE DRAWINGS

Example embodiments can be understood in more detail from the following description taken in conjunction with the accompanying drawings, in which:

FIG. 1 is a block diagram of an electronic device according to example embodiments;

FIG. 2 is a block diagram illustrating an example of a display device included in the electronic device of FIG. 1;

FIG. 3 is a diagram for explaining an example of oversize images and mask images generated in the electronic device of FIG. 1;

FIG. 4 is a diagram illustrating an example of output image of the electronic device of FIG. 1;

FIG. 5 is a diagram illustrating another example of output image of the electronic device of FIG. 1;

FIG. 6 is a diagram illustrating an example of the electronic device of FIG. 1 implemented as a head mounted display;

FIG. 7 is a diagram illustrating an example of the electronic device of FIG. 1 implemented as a smart phone; and

FIG. 8 is a flowchart of a method for displaying an image on a head mounted display device according to example embodiments.

### DETAILED DESCRIPTION OF EMBODIMENTS

Exemplary embodiments will be described more fully hereinafter with reference to the accompanying drawings, in which various embodiments are shown.

It will be understood that, although the terms “first”, “second”, “third”, etc., may be used herein to describe various elements, components, regions, layers, and/or sections, these elements, components, regions, layers, and/or sections should not be limited by these terms. These terms are used to distinguish one element, component, region, layer or section from another element, component, region, layer or section. Thus, a first element, component, region, layer, or section discussed below could be termed a second element, component, region, layer, or section, without departing from the spirit and scope of the present invention.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprise,” “comprises,” “comprising,” “includes,” “including,” and “include,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the present invention refers to “one or more embodiments of the present invention.” Also, the term “exemplary” is intended to refer to an example or illustration.

It will be understood that when an element or layer is referred to as being “on,” “connected to,” “coupled to,” “connected with,” “coupled with,” or “adjacent to” another element or layer, it can be “directly on,” “directly connected to,” “directly coupled to,” “directly connected with,” “directly coupled with,” or “directly adjacent to” the other element or layer, or one or more intervening elements or layers may be present. Further “connection,” “connected,” etc. may also refer to “electrical connection,” “electrically connect,” etc. depending on the context in which they are used as those skilled in the art would appreciate. When an element or layer is referred to as being “directly on,” “directly connected to,” “directly coupled to,” “directly connected with,” “directly coupled with,” or “immediately adjacent to” another element or layer, there are no intervening elements or layers present.

As used herein, the term “substantially,” “about,” and similar terms are used as terms of approximation and not as terms of degree, and are intended to account for the inherent deviations in measured or calculated values that would be recognized by those of ordinary skill in the art.

As used herein, the terms “use,” “using,” and “used” may be considered synonymous with the terms “utilize,” “utilizing,” and “utilized,” respectively.

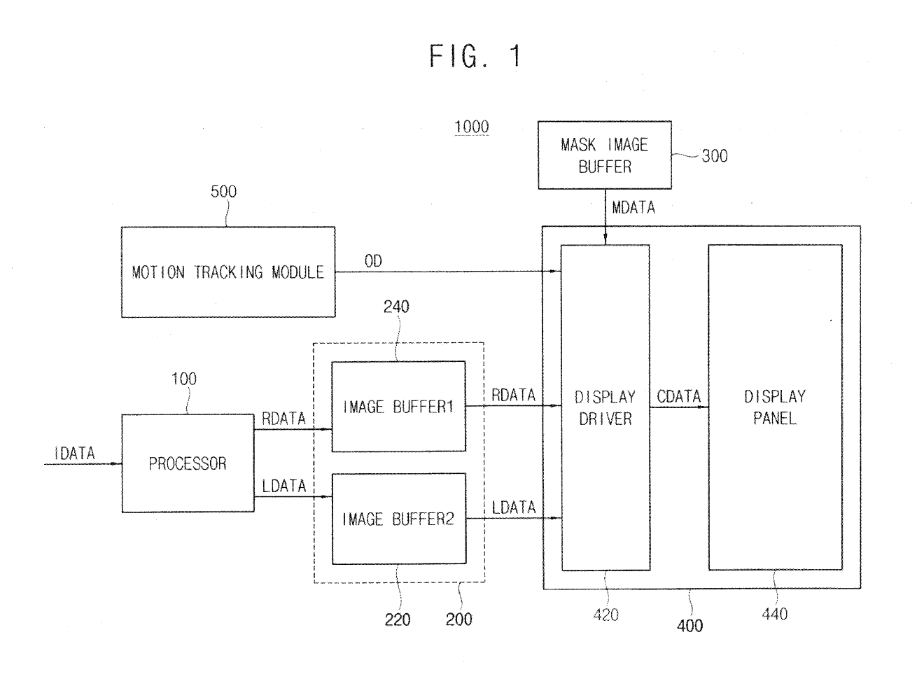

FIG. 1 is a block diagram of an electronic device according to example embodiments.

Referring to FIG. 1, the electronic device 1000 may include a processor 100, an image buffer 200, a mask image buffer 300, a display device 400, and a motion tracking module 500.

In some embodiments, the electronic device 1000 may be a head mounted display (HMD) device.

The processor 100 may generate an oversized image (e.g., oversized image data) LDATA and RDATA by rendering an input image (e.g., input image data) IDATA received from outside of the processor 100 (e.g., an externally received input image IDATA). The processor 100 may perform specific calculations, computing functions for various suitable tasks, operations, etc. The processor 100 may include, for example, a microprocessor, a central processing unit (CPU), or an application processor. The input image IDATA may include image data either taken from a camera unit, or provided from a content generation unit. When the electronic device 1000 displays a stereoscopic image, the processor 100 may receive a left-eye image and a right-eye image as the input image IDATA. In some embodiments, each of the left-eye image and the right-eye image includes an overlay image for an augmented reality see-through display. The processor 100 may perform the oversize rendering for each of the left-eye image and the right-eye image to generate the oversized image LDATA and RDATA. The oversized image LDATA and RDATA may include an oversized left-eye image (e.g., oversized left-eye image data) LDATA and an oversized right-eye image (e.g., oversized right-eye image data) RDATA. The oversize rendering may refer to the process of rendering images to have rendered images that are larger than actual display images. Thus, the oversized left-eye image LDATA and the oversized right-eye image RDATA may be larger than the image shown to a user. In some embodiments, the processor 100 may write the oversized left-eye image LDATA and the oversized right-eye image RDATA on the image buffer 200. In some embodiments, the processor 100 may further perform a filtering and a smoothing to eliminate a noise of the input image IDATA caused by the vibration (or a high-frequency motion) of the display device 400 or the electronic device 1000.

The image buffer 200 may store the oversized image LDATA and RDATA. The image buffer 200 may include a first image buffer 220 for storing the oversized left-eye image LDATA, and a second image buffer 240 for storing the oversized right-eye image RDATA. The image buffer 200 may transmit the oversized left-eye image LDATA and the oversized right-eye image RDATA to a display driver 420 of the display device 400. In some embodiments, the image buffer 200 may include a nonvolatile memory or a volatile memory.

The mask image buffer 300 may store a mask image (e.g., mask image data) MDATA that is smaller than the oversized image LDATA and RDATA. The mask image MDATA is an image used to separate an intended portion of a particular image from the rest of the particular image, and to synthesize the separated image portion with another image. A size of the mask image MDATA is smaller than the size of the oversized image LDATA and RDATA, so that the display device 400 may display a portion of the oversized image LDATA and RDATA. Accordingly, a rendered image size (i.e., a size of the oversized image) may be larger than the displayed image size (i.e., a size of an output image). In some embodiments, the image buffer 200 may include a nonvolatile memory or a volatile memory.

In some embodiments, the mask image buffer 300 may be included in the display driver 420, and the display driver 420 may read the mask image stored in the mask image buffer 300 once, or periodically, to generate an output image (e.g., an output image data) CDATA.

The display device 400 may apply an XY offset to the oversized image LDATA and RDATA based on orientation data OD in real time to generate an offset image. The display device 400 may blend the offset image with the mask image MDATA, which is smaller than the offset image, to display the output image CDATA, which is smaller than the oversized image LDATA and RDATA. The display device 400 may include the display driver 420 and a display panel 440.

The display device 400 may be the HMD device, or may be a portable display device. Thus, the display device 400 may be shaken (or moved) at a high speed by the user's sudden movement or vibration (or a high-frequency motion). The XY offset may be a data offset that shifts the displayed image in an X-axis direction and/or a Y-axis direction based on the shake (e.g., motion) of the display device 400. Thus, the XY offset may be applied when the display device 400 is shaken at a relatively high speed. For example, when the HMD device is rolled from side to side at a high speed, the image shown to the user may be stabilized by the XY offset. The display driver 420 may directly receive the orientation data OD from the motion tracking module 500, and may directly perform the XY offset, so that latency in an image updating process including the offset operation may be reduced to about 16 ms or less.

The display driver 420 may directly receive the orientation data OD from the motion tracking module 500, and may directly receive the mask image MDATA from the mask image buffer 300. The display driver 420 may generate XY offset data based on the orientation data OD, and may generate the offset image based on the XY offset data. Accordingly, the display driver 420 may generate the XY offset data while the processor 100 performs the oversize rendering of the input image IDATA. Thus, the latency in the image processed by the processor 100 may be reduced such that the latency in the image update may be reduced. In some embodiments, the display driver 420 may generate the offset image, at a high speed, within the size of the image buffer 200 based on the orientation data.

In some embodiments, the display driver 420 may apply the XY offset to the oversized image LDATA and RDATA at set scan periods (e.g., at predetermined scan periods). For example, the display driver 420 may apply the XY offset at every pixel row corresponding to each scan line. In some embodiments, the display driver 420 may apply the XY offset to the oversized image LDATA and RDATA at set scan frames (e.g., predetermined frames). For example, the display driver 420 may perform the XY offset at every frame.

The display driver 420 may blend the offset image with the mask image MDATA to generate the output image data CDATA.

The display panel 440 may include a plurality of pixels. The display panel 440 may be an organic light emitting display panel, a liquid crystal display panel, etc. However these are examples, and the display panel 440 is not limited thereto. The display panel 400 may also include a flexible display panel, a transparent display panel, etc. The display panel 440 may display the output image based on the output image data CDATA.

The motion tracking module 500 may sense the vibration (or the high-frequency motion) of the display device 400 to generate the orientation data OD. In some embodiments, the motion tracking module 500 may include at least one camera (e.g., a depth camera and/or a two-dimensional image camera) and/or an inertial motion tracker. The orientation data OD may include motion information of the user or of the display device 400. For example, the orientation data OD may have polar coordinate data, rectangular coordinate data, etc. to represent orientation information. The motion tracking module 500 may directly provide the orientation data OD to the display driver 420. Thus, the offset driving latency may be reduced by using the orientation data OD.

In some embodiments, the electronic device 1000 may further include a storage device, an I/O device, and a power supply. The storage device may include a solid state drive (SSD), a hard disk drive (HDD), a CD-ROM, etc. The I/O device may include one or more input devices (e.g., a keyboard, keypad, a mouse, a touch pad, a haptic device, etc.), and/or one or more output devices (e.g., a printer, a speaker, etc.). The power supply may apply a power to operate the electronic device 1000.

As described above, the electronic device 1000 including the HMD device may perform the oversize rendering for the high speed XY offset, and the display driver 420 may generate the XY offset data during the oversize rendering. Thus, the latency (or a latency interval) of the image processing operation, and the latency of the image offset operation, may be significantly reduced so that the overall system delay may be reduced. Further, the electronic device 1000 may display the offset image at the low latency by sensing the sudden movement of the display device 400 or of the user's head so that inconveniences, such as motion sickness, may be reduced.

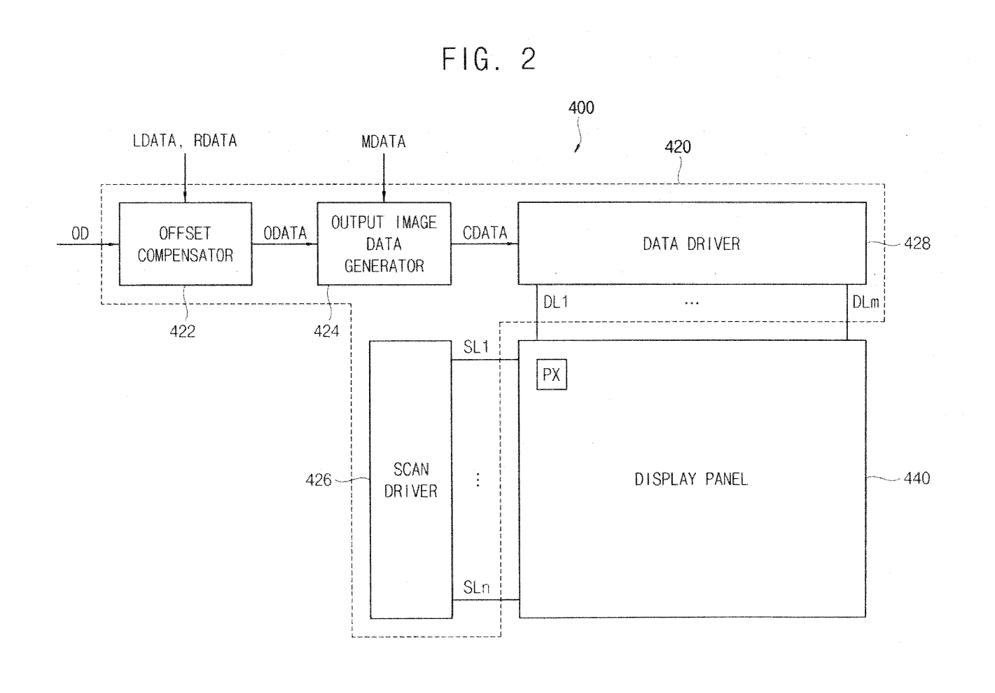

FIG. 2 is a block diagram illustrating an example of a display device included in the electronic device of FIG. 1.

Referring to FIG. 2, the display device 400 may include a display driver 420 and a display panel 440. The display device 400 may be a head mounted display (HMD) device.

The display panel 440 may include pixels respectively connected to scan lines SL1 to SLn and data lines DL1 to DLm.

The display driver 420 may include an offset compensator 422, an output image data generator 424, a scan driver 426, and a data driver 428. The display driver 420 may further include a controller for controlling the offset compensator 422, for controlling the output image data generator 424, for controlling the scan driver 426, and/or for controlling the data driver 428. In some embodiments, the offset compensator 422 and the output image data generator 424 may be included in the controller.

The offset compensator 422 may directly receive the orientation data OD from the motion tracking module 500. The offset compensator 422 may calculate a shift displacement of the display device 400 within a set time period (e.g., a predetermined time period) based on the orientation data OD to thereby generate XY offset data. For example, the offset compensator 422 may compare the orientation data OD at a first time point with the orientation data OD at a second time point, and may thereby calculate the shift displacement. The shift displacement may be converted into an (X, Y) coordinate pair of a hypothetical two-dimensional rectangular coordinate system. The shift displacement may include an amount of movement information of the display device 400. In some embodiments, a time difference between the first time point and the second time point may be about 32 ms. However, because these are examples, the time difference is not limited thereto. For example, the time difference may be less than about 32 ms.

The offset compensator 422 may apply the XY offset data to the oversized image LDATA and RDATA to generate the offset image ODATA, which is shifted in at least one of X-axis and Y-axis directions on a two-dimensional scene. In some embodiments, the offset image ODATA may be shifted in a direction corresponding to the shift displacement. For example, when a particular portion (or a predetermined portion) of the display device 400 is shifted to a coordinate (2, 3) in the rectangular coordinate system (e.g. the predetermined rectangular coordinate system), the offset image ODATA may correspond to a shifted image in which the oversized image LDATA and RDATA is shifted to the coordinate (e.g., a corresponding coordinate) (2, 3). In some embodiments, the offset image may be shifted in an opposite direction of the shift displacement. For example, when the display device 400 is shifted to a coordinate (2, 3) (or, the shift displacement is (2, 3)), the offset image ODATA may correspond to a shifted image in which the oversized image LDATA and RDATA is shifted to the coordinate (−2, −3). For a portable display device that is not the HMD device, the shifting operation (i.e., the operation of shifting in an opposite direction of the shift displacement) may be performed in the offset compensator 422.

The output image data generator 424 may blend the offset image ODATA with the mask image MDATA to generate the output image data CDATA corresponding to the output image that is recognized by a user. The mask image MDATA may have substantially the same size as the output image. Thus, a size of the oversized offset image ODATA (e.g., a size of an image corresponding to the oversized offset image data ODATA) may be converted into a size corresponding to a display area of the display panel 440 by the mask image MDATA.

The scan driver 426 may provide a scan signal to the scan lines SL1 to SLn based on a scan control signal. The scan control signal may be applied from the controller.

The data driver 428 may generate a data signal based on the output image data CDATA, and may provide the data signal to the data lines DL1 to DLm.

Accordingly, the display driver 400 may directly receive the orientation data OD from the motion tracking module 500 to thereby perform the high speed XY offset with respect to an unexpected vibration of the display device 400/electronic device 1000.

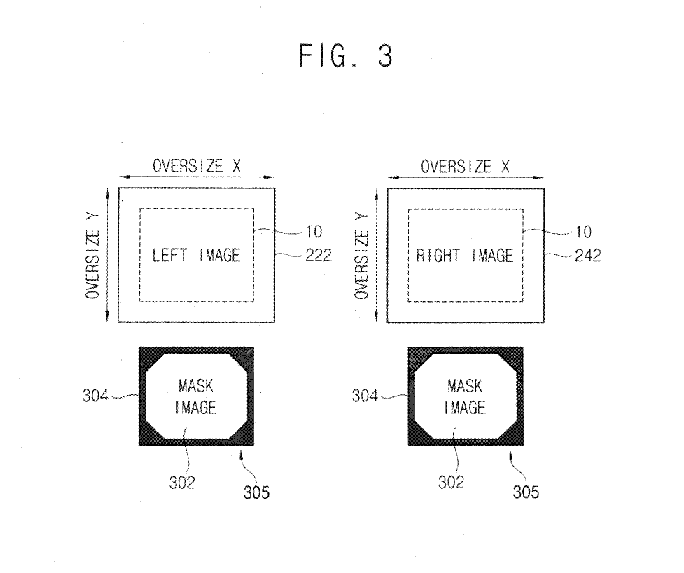

FIG. 3 is a diagram for explaining an example of oversized images and mask images generated in the electronic device of FIG. 1.

Referring to FIG. 3, the oversized images 222 and 242 may be generated to have larger sizes than output images 10.

The oversized images 222 and 242 may be generated by the processor that performs an oversize rendering of an input image. In some embodiments, the input image may include a left-eye image and a right-eye image (e.g., the input image IDATA may include the left-eye image LDATA and the right-eye image RDATA).

The processor 100 may perform oversize rendering OF each of the left-eye image and the right-eye image, such that the left-eye image and the right-eye image may be respectively converted into the oversized images 222 and 242. The oversized images 222 and 242 may be respectively stored in a plurality of image buffers (e.g., image buffers 220 and 240). The size of the oversized images 222 and 242 may be larger than the output images 10. For example, the oversized images 222 and 242 may be images that are expanded to a specific size in an X-axis direction and/or in a Y-axis direction. Here, the image buffers may be larger than a mask image buffer (e.g., mask image buffer 300). The oversized images 222 and 242 may be read from the image buffers, and may be provided to a display driver (e.g., display driver 420) of a display device.

The mask images 305 may be images used to separate intended portions of particular images (e.g., portions of the oversized images 222 and 242) from the rest of the particular images, and to synthesize the separated image portions with other images for the output images 10.

The mask images 305 may be divided into white regions 302 and black regions 304. The white regions 302 may be transparent. When the oversized images 222 and 242 and the mask images 305 are synthesized, portions of the oversized images 222 and 242 corresponding to the white regions 302 of the mask images 305 may be separated from the rest of the oversized images 222 and 242. Thus, the output images 10 corresponding to the display area of the display panel 440 may be generated. The white regions 302 of the mask images 305 have an octagonal form in the embodiment shown in FIG. 3, but the shape of the white regions is not limited thereto. The white regions 302 may have a shape corresponding to a scene, or shape, of the display device. For example, the white regions 302 may have a rectangular shape.

Because the offset images are larger than the output images, and because the image shift is performed within the oversized image buffer size, the latency in the image offset operation, and the image output latency, may be reduced.

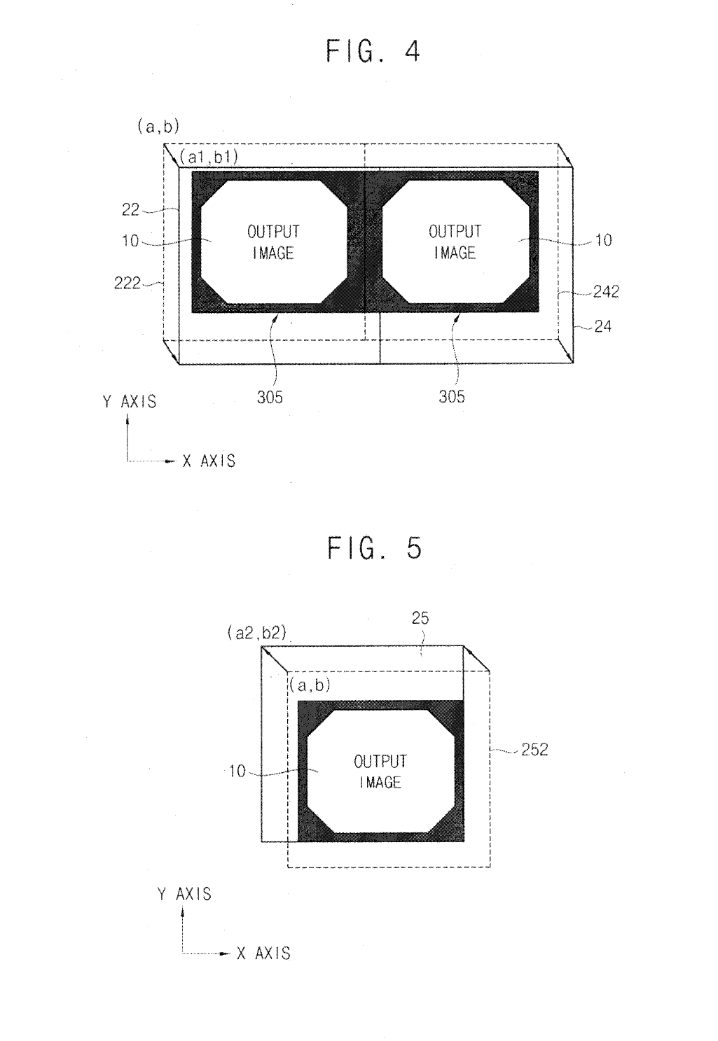

FIG. 4 is a diagram illustrating an example of the output image of the electronic device of FIG. 1, and FIG. 5 is a diagram illustrating another example of the output image of the electronic device of FIG. 1.

Referring to FIGS. 4 and 5, the oversized images 222 and 242 may be shifted based on orientation data. The shifted oversized images 222 and 242 may correspond to offset images 22 and 24.

In some embodiments, the orientation data OD may include motion information of the electronic device 1000 and/or orientation information, etc. For example, the orientation data OD may include angular displacement information including the orientation of the electronic device 1000. The angular displacement may include a coordinate value based on a polar coordinate system. In some embodiments, the display driver 420 may directly receive the polar coordinate data or a rectangular coordinate data to which the polar coordinate data is converted from the motion tracking module 500. In FIGS. 4 and 5, the orientation data OD are converted into the rectangular coordinate data.

At a first time point, the display driver 420 may receive the orientation data OD corresponding to a first coordinate (a1, b1) from the motion tracking module. At the same time, the processor 100 may perform the rendering of the input image IDATA to obtain the oversized images 222 and 242.

At a second time point, the electronic device 1000 may be shifted to a second coordinate (a2, b2) by a vibration or a high-frequency motion. The second time point may correspond to a delayed time point (e.g., a predetermined delayed time point), which is delayed from the first time point. For example, a time difference between the first and second time points may be about 32 ms. At the second time point, the display driver 420 may receive the orientation data OD corresponding to the second coordinate (a2, b2) from the motion tracking module 500. The display driver 420 may calculate a shift displacement based on the first coordinate (a1, b1) and the second coordinate (a2, b2) so as to generate an XY offset data. In some embodiments, the display driver 420 may generate the XY offset data while the processor 100 performs the oversize rendering.

The display driver 420 may apply the XY offset data to the oversized images 222 and 242 to generate the offset images 22 and 24. The offset images 22 and 24 may be shifted images, where the oversized images 222 and 242 are shifted in at least one of X-axis and Y-axis directions on a two-dimensional scene/plane based on the XY offset data. In some embodiments, the offset images 22 and 24 may be shifted in a direction corresponding to the shift displacement. As illustrated in FIG. 4, a specific portion of the oversized images 222 and 242 may be shifted from the first coordinate (a1, b1) to the second coordinate (a2, b2). Thus, the offset images 22 and 24 may be shifted in the X-axis direction by a2-a1, and may be shifted in the Y-axis direction by b2-b1

The display driver 420 may generate the output images 10 by blending the shifted offset images 22 and 24 with the mask image 305. Accordingly, the output image 10 shifted in the same, or substantially the same, direction as the motion of the user's head who wears the HMD device may be generated at a high speed. For example, when the HMD device is rolled from side to side, the electronic device 1000 may reflect the motion of the HMD device in real time to shift the output image 10 to the left or right. In addition, the latency may be significantly reduced compared with the typical HMD device such that a realism of usage of the HMD may be improved.

The display driver 420 may receive the first coordinate (a1, b1) at the first time point, and may receive the second coordinate (a2, b2) at the second time point. The display driver 420 may calculate the shift displacement based on the first and second coordinates (a1, b1) and (a2, b2) so as to generate the XY offset data. In some embodiments, the display driver 420 may shift the offset image in a direction opposite to that of the shift displacement.

As illustrated in FIG. 5, the display driver 420 may calculate a third coordinate (a3, b3) based on the shift displacement. The X-axis coordinate a3 of the third coordinate may correspond to a1+a2, and the Y-axis coordinate b3 of the third coordinate may correspond to b1+b2. Thus, the offset image 25 may be shifted in the X-axis direction by a2+a1, and may be shifted in the Y-axis direction by b2+b1. This driving operation may be applied in a portable display device that is not the HMD device. For example, when the electronic device 1000 shakes up and down, the electronic device 1000 may reflect the motion of the electronic device 1000 in real time to shift the output image 10 in the opposite direction of the motion.

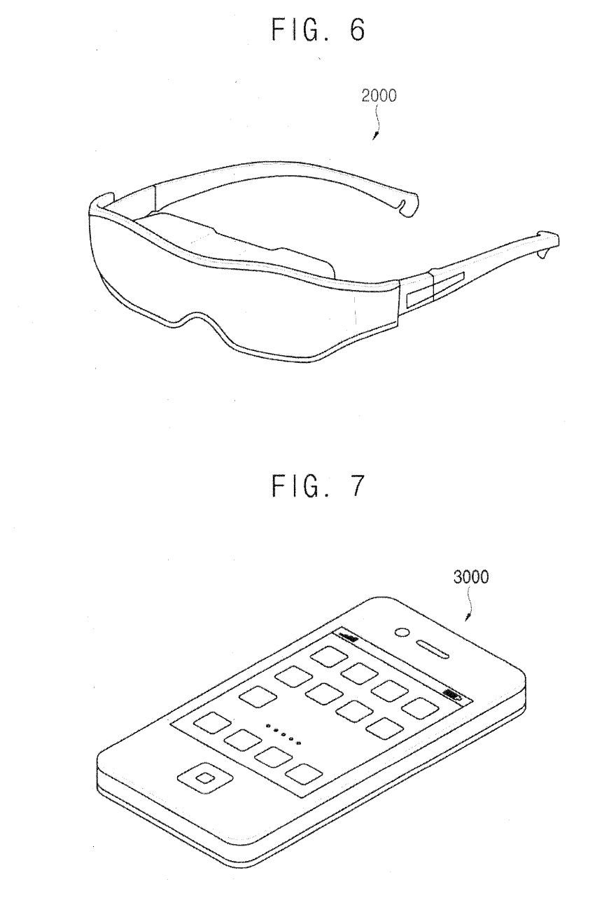

FIG. 6 is a diagram illustrating an example of the electronic device of FIG. 1 implemented as a head mounted display, and FIG. 7 is a diagram illustrating an example of the electronic device of FIG. 1 implemented as a smart phone.

Referring to FIGS. 1, 6, and 7, the electronic device 2000/3000 may include a processor 100, an image buffer 200, a mask image buffer 300, a display device 400, and a motion tracking module 500. The electronic device 2000/3000 may further include a plurality of ports that communicate, for example, with a video card, a sound card, a memory card, a universal serial bus (USB) device, other suitable electric devices, etc. In some embodiments, the electronic device 2000/3000 may further include a storage device, an I/O device, and a power supply. Because these are described above, duplicated descriptions may be omitted.

In some embodiments, as illustrated in FIG. 6, the electronic device 2000 may be a head mounted display (HMD) device. An output image shifted in the same, or in substantially the same, direction as the motion of the user's head who wears the HMD device may be generated at a high speed. For example, when the user's head is rolled from side to side, the electronic device 2000 may reflect the motion of the HMD device in real time to shift the output image in the same, or in substantially the same, direction as the user's motion. In addition, the latency may be significantly reduced compared with the typical HMD device such that realism of usage of the HMD may be improved.

In some embodiments, as illustrated in FIG. 7, the electronic device 300 may be a smart phone. In some embodiments, an output image shifted in an opposite direction of the motion of the smart phone may be generated at a high speed. For example, when the smart phone shakes up and down, the smart phone 3000 may reflect the motion in real time to shift the output image in the opposite direction of the motion. Thus, the output image shown to the user may be stabilized.

Because these are examples, the electronic devices 2000/3000 are not limited thereto. For example, the electronic device may include a cellular phone, a video phone, a smart pad, a smart watch, a tablet, a personal computer, an automotive navigation, a notebook, a monitor, etc.

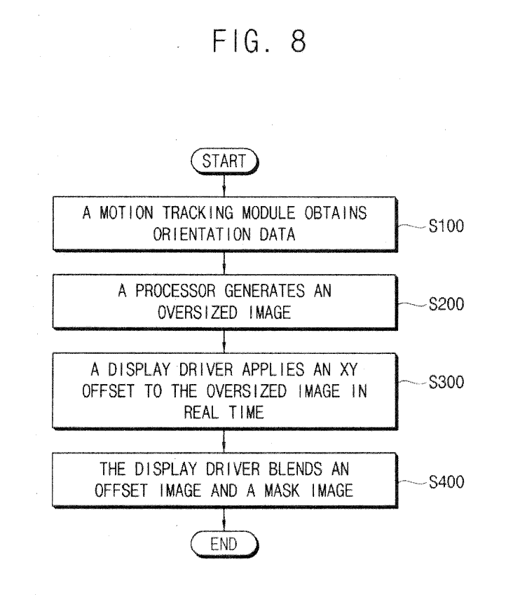

FIG. 8 is a flowchart of a method for displaying an image on a head mounted display device according to example embodiments.

Examples of the HMD display device are described above with reference to FIGS. 1 to 5. As such, duplicate descriptions may be omitted.

Referring to FIG. 8, the method for displaying an image of the HMD device may include obtaining orientation data OD by sensing a vibration (or a high-frequency motion) of the HMD device (S100), generating an oversized image by rendering a left-eye image and a right-eye image (S200), applying an XY offset to the oversized image based on the orientation data OD (S300), and blending an offset image with a mask image (S400) to generate an output image data. The offset image may be generated by the XY offset.

A motion tracking module may sense the vibration of the HMD device and obtain the orientation data OD (S100). The orientation data OD may include motion and orientation information of the HMD device. For example, the orientation data OD may include angular displacement information including the orientation of the HMD device. The angular displacement may include a coordinate value based on a polar coordinate system. The orientation data OD may be directly transmitted from the motion tracking module to a display driver.

A processor may generate the oversized image by the oversize rendering of the left-eye image and the right-eye image provided from outside (S200). In some embodiments, each of the left-eye image and the right-eye image may include an overlay image for an augmented reality see-through display. The oversized left-eye image and the oversized right-eye image may have larger sizes than the image shown to a user. In some embodiments, the processor may write the oversized left-eye image and the oversized right-eye image on an image buffer. The XY offset reflecting the high-frequency motion (or vibration) of the HMD device in real time may be performed within the oversized image such that the XY offset may immediately respond to the motion (or vibration) of the HMD device.

The display driver may apply the XY offset to the oversized image in real time based on the orientation data OD (S300). The display driver may directly receive the orientation data OD from the motion tracking module. The display driver may generate the XY offset data while the processor performs the oversize rendering. Thus, the image processing latency of the processor may be reduced, and the latency in an image updating may be reduced. In some embodiments, the display driver may apply the XY offset to the oversized image at set scan periods (e.g., predetermined scan periods). For example, the display driver may apply the XY offset at each pixel row corresponding to each scan line. Thus, the output image reflecting the high speed motion may be displayed.

For example, the display driver may generate the XY offset data based on the orientation data OD including the polar coordinate data. The display driver may apply the XY offset data to the oversized image to generate the offset image that is a shifted oversized image in an X-axis direction and/or a Y-axis direction.

The display driver may blend the offset image with the mask image smaller than the oversized image to generate the output image data (S400). The mask image may have substantially the same size as the output image. Thus, a size of the oversized offset image may be converted into a size corresponding to a display area by the mask image. In some embodiments, the offset image may be shifted corresponding to a shift displacement of the HMD device within a set time period (e.g., a predetermined time period). Accordingly, the output image shifted in the same, or in substantially the same, direction as the motion of the user's head who wears the HMD device may be generated at a high speed. For example, when the HMD device is rolled from side to side, the HMD device may reflect the motion of the HMD device in real time to shift the output image to the left or right. Because these are described above with reference to FIGS. 1 to 4, duplicated descriptions may be omitted.

As described above, the method for displaying the image of the HMD device may perform the XY offset operation and the image processing operation at a high speed, so that the image display latency may be significantly reduced. Thus, the HMD device may perform the XY offset operation to the output image in real time reflecting the sudden movement (or the vibration) of HMD device. Therefore, the user's inconvenience in using of the HMD device, such as motion sickness, and nausea, etc., may be decreased, and the realism of the augmented reality experiences may be improved.

The present embodiments may be applied to any display device and any system including the display device. For example, the present embodiments may be applied to a head mounted display (HMD) device, a television, a computer monitor, a laptop, a digital camera, a cellular phone, a smart phone, a smart pad, a personal digital assistant (PDA), a portable multimedia player (PMP), a MP3 player, a navigation system, a game console, a video phone, etc.

The foregoing is illustrative of example embodiments, and is not to be construed as limiting thereof. Although a few example embodiments have been described, those skilled in the art will readily appreciate that many modifications are possible in the example embodiments without materially departing from the novel teachings and advantages of example embodiments. Accordingly, all such modifications are intended to be included within the scope of example embodiments as defined in the claims. In the claims, means-plus-function clauses are intended to cover the structures described herein as performing the recited function and not only structural equivalents but also equivalent structures. Therefore, it is to be understood that the foregoing is illustrative of example embodiments and is not to be construed as limited to the specific embodiments disclosed, and that modifications to the disclosed example embodiments, as well as other example embodiments, are intended to be included within the scope of the appended claims. The inventive concept is defined by the following claims, with equivalents of the claims to be included therein.

What is claimed is:

1. An electronic device, comprising:
a processor configured to generate an oversized image by rendering an externally received input image;
an image buffer configured to store the oversized image;
a mask image buffer configured to store a mask image, which is smaller than the oversized image;
a display device configured to:
apply, in real time, an XY offset to the oversized image based on orientation data to generate an offset image; and
blend the offset image with the mask image to display an output image, which is smaller than the oversized image; and
a motion tracking module configured to:
sense a movement of the display device; and
generate the orientation data.

2. The electronic device of claim 1, wherein the display device comprises:
a display driver configured to:
directly receive the orientation data from the motion tracking module;
directly receive the mask image from the mask image buffer;
generate XY offset data corresponding to the XY offset based on the orientation data; and
generate output image data by blending the offset image with the mask image; and
a display panel, comprising a plurality of pixels, configured to display the output image based on the output image data.

3. The electronic device of claim 2, wherein the display driver is configured to generate the XY offset data while the processor performs the oversize rendering.

4. The electronic device of claim 3, wherein the display driver is further configured to shift the oversized image within a size of the oversized image buffer based on the orientation data.

5. The electronic device of claim 3, wherein the display driver is further configured to apply the XY offset to the oversized image at set scan periods.

6. The electronic device of claim 3, wherein the display driver is further configured to apply the XY offset to the oversized image at set frames.

7. The electronic device of claim 2, wherein the display driver comprises:
an offset compensator configured to:
calculate a shift displacement of the display device, within a set time period, based on the orientation data to generate the XY offset data; and
apply the XY offset to the oversized image to generate the offset image, which is shifted in at least one of an X-axis direction or a Y-axis direction on a two-dimensional plane; and
an output image data generator configured to blend the offset image with the mask image to generate the output image data corresponding to the output image.

8. The electronic device of claim 7, wherein the offset image is shifted in a direction corresponding to a direction of the shift displacement.

9. The electronic device of claim 7, wherein the offset image is shifted in a direction opposite to a direction of the shift displacement.

10. The electronic device of claim 7, wherein the display driver further comprises:
a data driver configured to:
generate a data signal based on the output image data; and
provide the data signal to the display panel via a data line; and
a scan driver configured to provide a scan signal to the display panel via a scan line.

11. The electronic device of claim 1, wherein the display device comprises a head mounted display (HMD) device.

12. The electronic device of claim 11, wherein the input image comprises a stereoscopic image having a left-eye image and a right-eye image.

13. The electronic device of claim 12, wherein the processor is further configured to perform the oversized image rendering for each of the left-eye image and the right-eye image.

14. The electronic device of claim 12, wherein each of the left-eye image and the right-eye image comprises an overlay image for an augmented reality see-through display.

15. The electronic device of claim 12, wherein the processor is further configured to perform filtering and smoothing to eliminate noise in the input image caused by the movement.

16. A method for displaying an image on a head mounted display (HMD) device, the method comprising:
sensing, by a motion tracking module, a movement of the HMD device to obtain orientation data;
generating, by a processor, an oversized image by rendering a left-eye image and a right-eye image, which are externally provided;
applying, by a display driver, in real time, an XY offset to the oversized image based on the orientation data;
applying the XY offset to the oversized image to generate an offset image; and
generating, by the display driver, output image data by blending an offset image with a mask image, which is smaller than the oversized image.

17. The method of claim 16, further comprising directly transmitting the orientation data from the motion tracking module to the display driver.

18. The method of claim 17, further comprising generating the XY offset data using the display driver while the processor performs the oversized image rendering.

19. The method of claim 16, further comprising applying the XY offset to the oversized image at set scan periods.

20. The method of claim 16, further comprising shifting the offset image corresponding to a shift displacement of the HMD device within a set time period.
